(19) United States
(12) Patent Application Publication
(10) Pub. No.: US 2020/0031462 A1
(43) Pub. Date: Jan. 30, 2020

(54) COAXIAL SINGLE-BLADED ROTOR STOPPED-ROTOR VERTICAL TAKE-OFF AND LANDING AIRCRAFT AND ASSOCIATED METHOD OF FLYING

(71) Applicant: The Boeing Company, Chicago, IL (US)

(72) Inventor: Charles R. Svoboda, JR., University City, MO (US)

(21) Appl. No.: 16/049,509

(22) Filed: Jul. 30, 2018

(51) Int. Cl. B64C 29/00; B64C 11/28; B64C 11/48; B64C 3/38

(52) U.S. Cl. CPC B64C 29/0025; B64C 11/28; B64C 15/14; B64C 3/385; B64C 11/48

(57) ABSTRACT

An aircraft comprising fixed wings, an upper rotor system, and a lower rotor system. The upper rotor system comprises only one upper blade. Furthermore, the upper rotor system is configured to rotate the upper blade in a clockwise rotational direction about a yaw axis of the aircraft in a vertical take-off mode, and halt rotation of the upper blade in a first rearward orientation parallel to the roll axis of the aircraft in a high-speed cruise mode. The lower rotor system comprises only one lower blade. Additionally, the lower rotor system is configured to rotate the lower blade in a counter-clockwise rotational direction, opposite the clockwise rotational direction, about the yaw axis in the vertical take-off mode, and halt rotation of the lower blade in a second rearward orientation parallel to the roll axis in the high-speed cruise mode.

### FIELD

This disclosure relates generally to aircraft, and more particularly to vertical take-off and landing aircraft.

### BACKGROUND

Some vertical take-off and landing aircraft employ rotors to lift the aircraft. Certain types of vertical take-off and landing aircraft, such as stopped-rotor aircraft with fixed-wing lifting surfaces, stop the rotors at some forward velocity of the aircraft corresponding with the fixed-wing lifting surfaces providing enough lift to zero pitch the rotor blades and stop the rotor. Then, the stopped rotors are utilized as wings. Although stopped rotors acting as wings can provide lift to the aircraft, such stopped rotors also induce drag on the aircraft.

### SUMMARY

The subject matter of the present application has been developed in response to the present state of the art, and in particular, in response to the problems and disadvantages associated with conventional stopped-rotor aircraft that have not yet been fully solved by currently available techniques. Accordingly, the subject matter of the present application has been developed to provide a stopped-rotor aircraft that overcomes at least some of the above-discussed shortcomings of prior art techniques.

Disclosed herein is an aircraft, comprising a fuselage comprising a forward fuselage and a rear fuselage. The fuselage extends parallel to a roll axis of the aircraft from the forward fuselage to the rear fuselage. The aircraft also comprises fixed wings coupled to the fuselage and extending from opposite sides of the fuselage in directions parallel or oblique to a pitch axis of the aircraft. The pitch axis is perpendicular to the roll axis. The aircraft further comprises an upper rotor system coupled to the fuselage. The upper rotor system comprises only one upper blade. Furthermore, the upper rotor system is configured to rotate the upper blade in a clockwise rotational direction about a yaw axis of the aircraft in a vertical take-off mode, wherein the yaw axis is perpendicular to the roll axis and the pitch axis, and halt rotation of the upper blade in a first rearward orientation parallel to the roll axis of the aircraft in a high-speed cruise mode. The aircraft additionally comprises a lower rotor system coupled to the fuselage. The lower rotor system comprises only one lower blade. Additionally, the lower rotor system is configured to rotate the lower blade in a counter-clockwise rotational direction, opposite the clockwise rotational direction, about the yaw axis in the vertical take-off mode, and halt rotation of the lower blade in a second rearward orientation parallel to the roll axis in the high-speed cruise mode. The preceding subject matter of this paragraph characterizes example 1 of the present disclosure.

The upper blade is offset from the lower blade in a direction parallel to the yaw axis. The preceding subject matter of this paragraph characterizes example 2 of the present disclosure, wherein example 2 also includes the subject matter according to example 1, above.

Each fixed wing comprises a fixed wing root, non-movably fixed relative to the fuselage, and a pitchable wing, rotatably coupled to the fixed wing root and rotatable relative to the fixed wing root. The preceding subject matter of this paragraph characterizes example 3 of the present disclosure, wherein example 3 also includes the subject matter according to any one of examples 1-2, above.

The pitchable wing is substantially parallel to the yaw axis in the vertical take-off mode. The pitchable wing is substantially parallel to the roll axis in the high-speed cruise mode. The preceding subject matter of this paragraph characterizes example 4 of the present disclosure, wherein example 4 also includes the subject matter according to example 3, above.

The aircraft further comprises pitch thrust ports each in a corresponding one of a top and a bottom of the rear portion of the fuselage. The preceding subject matter of this paragraph characterizes example 5 of the present disclosure, wherein example 5 also includes the subject matter according to any one of examples 1-4, above.

The aircraft further comprises yaw thrust ports each in a corresponding one of opposing sides of the rear portion of the fuselage. The preceding subject matter of this paragraph characterizes example 6 of the present disclosure, wherein example 6 also includes the subject matter according to any one of examples 1-5, above.

Each of upper blade and the lower blade has an airfoil cross-sectional shape with a blunt leading edge and a pointed trailing edge. The preceding subject matter of this paragraph characterizes example 7 of the present disclosure, wherein example 7 also includes the subject matter according to any one of examples 1-6, above.

The aircraft further comprises a forward thrust system separate from the upper rotor system and the lower rotor system. The preceding subject matter of this paragraph characterizes example 8 of the present disclosure, wherein example 8 also includes the subject matter according to any one of examples 1-7, above.

In the high-speed cruise mode, the upper blade at least partially overlaps the lower blade in a direction parallel to the yaw axis. The preceding subject matter of this paragraph characterizes example 9 of the present disclosure, wherein example 9 also includes the subject matter according to any one of examples 1-8, above.

A pitch of the upper blade and the lower blade is adjustable. The pitch of the upper blade and the lower blade is zero during the vertical take-off mode and the high-speed cruise mode. The pitch of the upper blade and the lower blade is greater than zero during a low-speed forward rotary flight. The preceding subject matter of this paragraph characterizes example 10 of the present disclosure, wherein example 10 also includes the subject matter according to any one of examples 1-9, above.

The upper blade and the lower blade are configured to provide at least a portion of forward thrust and lift of the aircraft during the low-speed forward rotary flight. The upper blade and the lower blade are configured to provide no thrust and no lift of the aircraft during the high-speed cruise mode. The preceding subject matter of this paragraph characterizes example 11 of the present disclosure, wherein example 11 also includes the subject matter according to example 10, above.

Also disclosed herein is a vertical take-off and landing (VTOL) aircraft that comprises a fuselage and fixed wings coupled to the fuselage. The VTOL aircraft also comprises an upper blade rotatably coupled to the fuselage and rotatable about a rotational axis parallel to a yaw axis of the VTOL aircraft in a clockwise rotational direction. The VTOL aircraft additionally comprises a lower blade rotatably coupled to the fuselage and rotatable about the rotational axis in a counter-clockwise rotational direction opposite the clockwise rotational direction. Rotation of the upper blade and the lower blade is haltable, during flight of the VTOL aircraft, with the upper blade and the lower blade extending in a rearward direction relative to the fuselage from corresponding rotor blade roots to corresponding free ends of the upper blade and the lower blade. The preceding subject matter of this paragraph characterizes example 12 of the present disclosure.

The upper blade is vertically offset from the lower blade when rotation of the upper blade and the lower blade is halted with the upper blade and the lower blade extending in a rearward direction from corresponding fixed ends to corresponding free ends of the upper blade and the lower blade. The preceding subject matter of this paragraph characterizes example 13 of the present disclosure, wherein example 13 also includes the subject matter according to example 12, above.

Each of upper blade and the lower blade has an airfoil cross-sectional shape with a blunt leading edge and a pointed trailing edge. The preceding subject matter of this paragraph characterizes example 14 of the present disclosure, wherein example 14 also includes the subject matter according to any one of examples 12-13, above.

In a vertical take-off mode, the upper blade and the lower blade provide all lift of the VTOL aircraft. In a low-speed forward rotary flight, the upper blade and the lower blade provide at least some lift and at least some forward thrust of the VTOL aircraft. In a high-speed cruise mode, the upper blade and the lower blade provide no lift and no forward thrust of the VTOL aircraft. The preceding subject matter of this paragraph characterizes example 15 of the present disclosure, wherein example 15 also includes the subject matter according to any one of examples 12-14, above.

In the vertical take-off mode, the upper blade and the lower blade are not pitched. In the low-speed forward rotary flight, the upper blade and the lower blade are pitched. In the high-speed cruise mode, the upper blade and the lower blade are not pitched. The preceding subject matter of this paragraph characterizes example 16 of the present disclosure, wherein example 16 also includes the subject matter according to example 15, above.

Further disclosed herein is a method of flying an aircraft comprising fixed wings. The method comprises rotating an upper blade of the aircraft in a clockwise rotational direction about a yaw axis of the aircraft to partially lift the aircraft and rotating a lower blade of the aircraft in a counter-clockwise rotational direction, opposite the clockwise rotational direction, about the yaw axis of the aircraft to partially lift the aircraft. The method further comprises providing a first forward thrust of the aircraft independently of rotation of the upper blade and the lower blade. The method additionally comprises decreasing pitch of the upper blade and the lower blade, to reduce lift generated by the upper blade and the lower blade, as lift generated by the fixed wings increases. The method also comprises, while providing the first forward thrust of the aircraft and with the upper blade and the lower blade at zero pitch, halting the rotation of the upper blade and the lower blade with the upper blade and the lower blade extending in a rearward direction relative to the aircraft. The preceding subject matter of this paragraph characterizes example 17 of the present disclosure.

The method further comprises pitching the upper blade and the lower blade to provide a second forward thrust of the aircraft from rotation of the upper blade and the lower blade. The preceding subject matter of this paragraph characterizes example 18 of the present disclosure, wherein example 18 also includes the subject matter according to example 17, above.

The method also comprises providing at least one of a pitch adjustment thrust and a yaw adjustment thrust of the aircraft while rotating the upper blade and the lower blade. The preceding subject matter of this paragraph characterizes example 19 of the present disclosure, wherein example 19 also includes the subject matter according to any one of examples 17-18, above.

The rearward direction is parallel to a roll axis of the aircraft and, when rotation of the upper blade and the lower blade is halted, the upper blade overlaps the lower blade in a direction parallel to a yaw axis of the aircraft. The preceding subject matter of this paragraph characterizes example 20 of the present disclosure, wherein example 20 also includes the subject matter according to any one of examples 17-19, above.

Additionally disclosed herein is a method of flying an aircraft. The method comprises providing an aircraft comprising a fuselage and pitchable wings tiltably coupled to the fuselage. The pitchable wings are selectively tiltable about an axis parallel to a pitch axis of the aircraft to adjust a pitch of the pitchable wings relative to the fuselage. The method also comprises determining a desired pitch of the fuselage corresponding with a minimum amount of drag generated by the fuselage. The method further comprises tilting the pitchable wings relative to the fuselage to adjust the pitch of the pitchable wings and to cause the fuselage to rotate about the pitch axis to the desired pitch. The preceding subject matter of this paragraph characterizes example 21 of the present disclosure.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

That the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not, therefore, to be considered to be limiting of its scope, the subject matter will be described and explained with additional specificity and detail through the use of the drawings, in which:

FIG. 1 is a perspective view of an aircraft, operating in a vertical take-off mode, according to one or more examples of the present disclosure;

FIG. 2 is a top plan view of the aircraft of FIG. 1, according to one or more examples of the present disclosure;

FIG. 3 is a rear view of the aircraft of FIG. 1, according to one or more examples of the present disclosure;

FIG. 4 is a side elevation view of the aircraft of FIG. 1, according to one or more examples of the present disclosure;

FIG. 5 is a perspective view of the aircraft of FIG. 1, operating in a low-speed forward rotary flight, according to one or more examples of the present disclosure;

FIG. 6 is a perspective view of the aircraft of FIG. 1, operating in the low-speed forward rotary flight, according to one or more examples of the present disclosure;

FIG. 7 is a side elevation view of the aircraft of FIG. 1, operating in the low-speed forward rotary flight, according to one or more examples of the present disclosure;

FIG. 8 is a perspective view of the aircraft of FIG. 1, operating in a high-speed cruise mode, according to one or more examples of the present disclosure;

FIG. 9 is a top plan view of the aircraft of FIG. 1, operating in a high-speed cruise mode, according to one or more examples of the present disclosure;

FIG. 10 is a front view of the aircraft of FIG. 1, operating in a high-speed cruise mode, according to one or more examples of the present disclosure;

FIG. 11 is a side elevation view of the aircraft of FIG. 1, operating in a high-speed cruise mode, according to one or more examples of the present disclosure;

FIG. 12 is a cross-sectional side elevation view of a blade of the aircraft of FIG. 1, taken along a line 12-12 of FIG. 1, according to one or more examples of the present disclosure;

FIG. 13 is a schematic flow diagram of a method of flying an aircraft, according to one or more examples of the present disclosure; and

FIG. 14 is a schematic flow diagram of another method of flying an aircraft, according to one or more examples of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The present disclosure provides a stopped-rotor aircraft that improves flying performance by reducing drag generated by stopped rotors and improving the aerodynamic efficiency of the rotors in hover. Some conventional stopped-rotor aircraft utilize stopped rotors as wings to generate lift. While improving lift performance of the aircraft by supplementing the lift provided by fixed wings, these stopped rotors also generate significant drag on the aircraft in fixed wing cruise flight conditions. The added drag caused by the stopped rotors results in a reducing flying efficiency of the aircraft. Additionally, because the blades of the rotors of such conventional stopped-rotor aircraft rotate in the same rotational direction, but must also provide lift of the aircraft when stopped, the shape of the blades are not optimized for rotary lift of the aircraft. More specifically, both the leading edges and the trailing edges of the blades, of such conventional stopped-rotor aircraft, are blunt. As described below, the stopped-rotor aircraft of the present disclosure does not use the stopped rotors as wings to generate lift and thus the rotors can be oriented rearward (along the fuselage with the tips pointing aft) when stopped to reduce drag and can have a shape more optimized for rotary lift of the aircraft. Accordingly, the stopped-rotor aircraft of the present disclosure improves cruise efficiency and lift efficiency compared to conventional stopped-rotor aircraft.

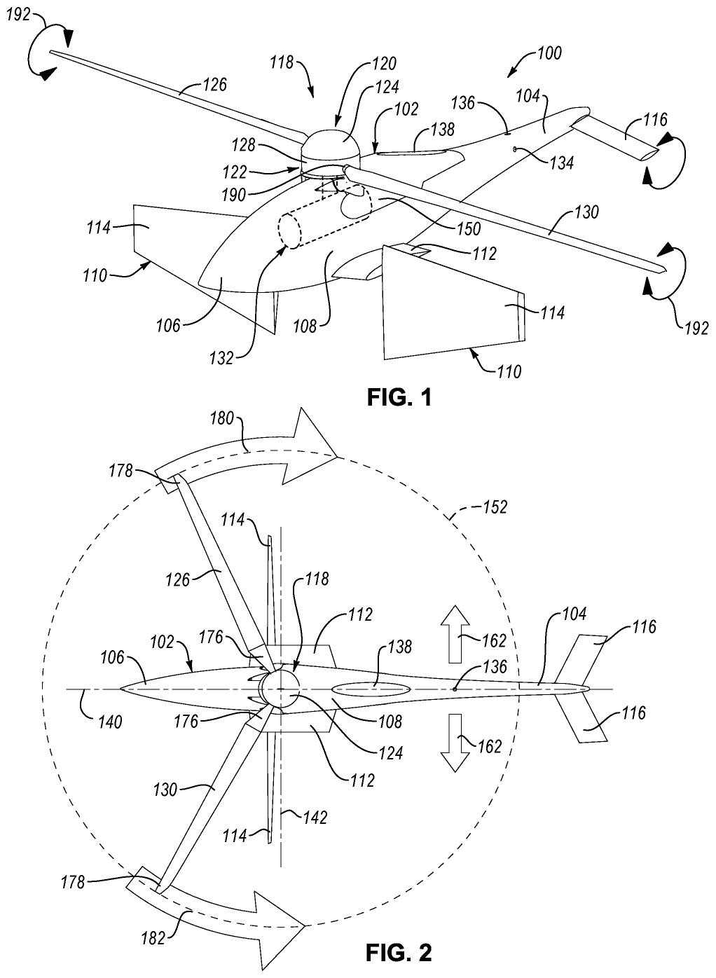

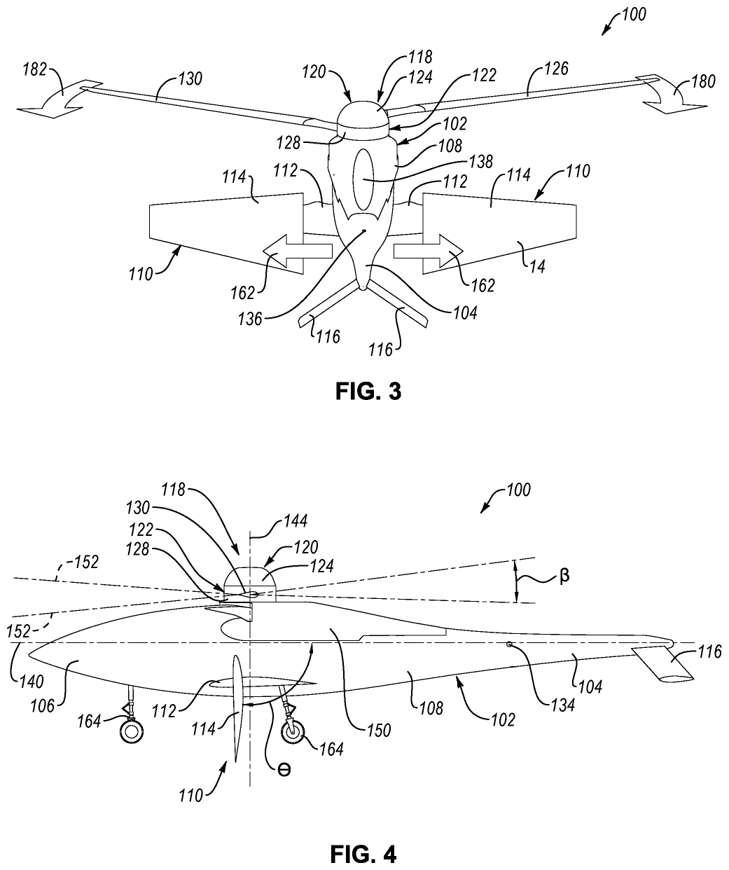

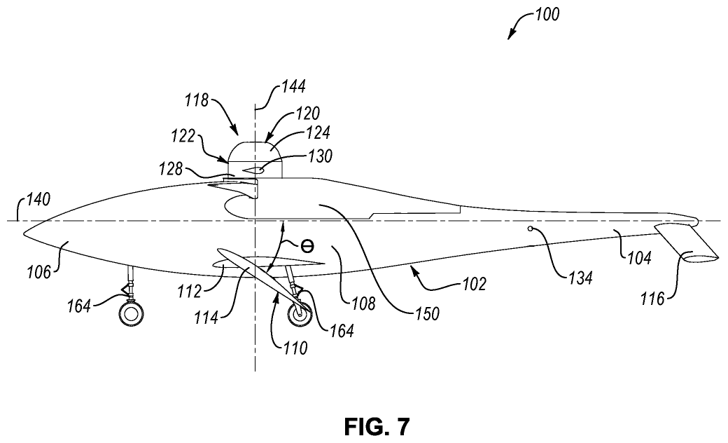

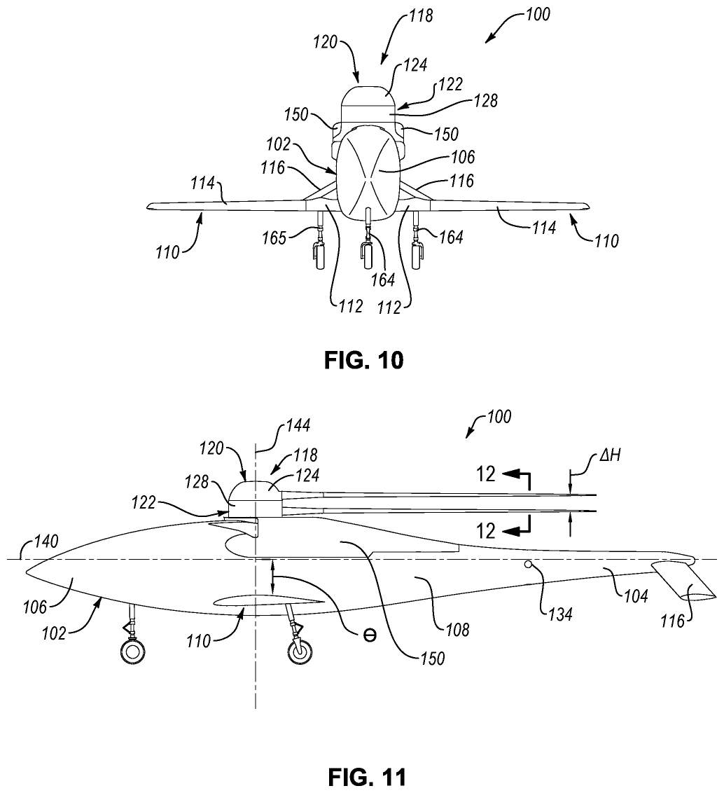

Referring to FIGS. 1-11, one embodiment of an aircraft 100 is shown. The aircraft 100 is a vertical take-off and landing (VTOL) aircraft in some examples. The aircraft 100 includes a fuselage 102 (e.g., fuselage), a pair of fixed wings 110 coupled to and extending from the fuselage 102, empannage 116 also coupled to and extending from the fuselage 102, and a rotor system 118 coupled to the fuselage 102. The fuselage 102 includes a forward fuselage 106 (fore of the rotor system 118), an aft fuselage 104 (aft of the rotor system 118), and a mid-fuselage 108 (under a center of the rotor system 118) between the forward fuselage 106 and the aft fuselage 104. The forward fuselage 106 includes the nose of the aircraft 100 and the aft fuselage 104 includes the empennage of the aircraft 100. Generally, the fuselage 102 is elongated and extends lengthwise generally parallel to the roll axis 140 of the aircraft 100 from the forward fuselage 106 to the aft fuselage 104. As defined herein, the rearward direction is a direction parallel to the roll axis 140 of the aircraft 100 and extending from the forward fuselage 106 to the aft fuselage 104.

The fixed wings 110 are coupled to and extend from opposite sides of the mid-fuselage 108 of the fuselage 102. In some examples, such as shown, the fixed wings 110 extend in directions generally parallel to the pitch axis 142 of the aircraft 100. The pitch axis 142 of the aircraft 100 is perpendicular to the roll axis 140. According to other examples, a spanwise direction of the fixed wings 110 is oblique to the pitch axis 142. For example, the fixed wings 110 can be rearward-swept wings or forward-swept wings to enable higher maximum speeds in some implementations. Each fixed wing 110 is an airfoil. In other words, the cross-sectional shape of each fixed wing 110 at any location spanwise along the fixed wing 110 is an airfoil with a blunt leading edge and a sharp converging trailing edge. Although not shown, each fixed wing 110 may include aerodynamic control surfaces, such as flaps, ailerons, spoilers, and the like.

Each fixed wing 110 includes a fixed wing root 112 and a pitchable wing 114. The fixed wing root 112 is non-movably fixed relative to the fuselage 102, such as a lower section of the mid-fuselage 108 of the fuselage 102. The pitchable wing 114 is movably fixed (e.g., rotatably coupled) to the fixed wing root 112. In the illustrated example, the pitchable wing 114 is selectively rotatable relative to the fixed wing root 112. The pitchable wing 114 can be rotatable about any of various axes relative to the fixed wing root 112 that will reduce the download from the rotor system 118. In one example, the pitchable wing 114 rotates about an axis parallel to the pitch axis 142. In the same or a different example, the pitchable wing 114 rotates about an axis that is parallel to a spanwise direction of the fixed wing 110, thus capable of accommodating a sweep angle if necessary. The pitchable wing 114 of each fixed wing 110 is rotatable relative to the fixed wing root 112 of the corresponding fixed wing 110 to change a pitch of the pitchable wing 114 relative to the fixed wing root 112 and thus the fuselage 102.

The empennage 116 is coupled to and extends from the aft fuselage 104 of the fuselage 102. The empennage 116 is shown as an inverted V-tail but could include any number of empennage implementations, including canards. The empennage 116 may have anhedral and form an inverted V-shape as shown. In other examples, the empennage 116 have dihedral to form an upward V-shape, or no dihedral and a vertical tail may also comprise the empennage 116. In any case, as shown in FIG. 1, in some examples, the empennage 116 can rotate in pitch, to minimize the download of the rotor system 118, similar to the pitchable wing 114. This is helpful when the rotor system 118 is turning and the forward motion of the aircraft 110 causes the rotor wake to sweep aft over the empennage 116. In other words, the empennage 116, being able to rotate in pitch, helps to reduce drag, reduce download, and/or increase control effectiveness when the rotor wake is impacting the fuselage. Although not shown, the empennage 116 may include aerodynamic control surfaces, such as flaps.

The rotor system 118 includes an upper rotor system 120 and a lower rotor system 122 each yaw-rotatably coupled to a top of the mid-fuselage 108 of the fuselage 102. The upper rotor system 120 includes an upper hub 124 and an upper blade 126 coupled to and extending from the upper hub 124. Similarly, the lower rotor system 122 includes a lower hub 128 and a lower blade 130 coupled to and extending from the lower hub 128. In the illustrated example, the upper rotor system 120 includes only one upper blade 126 and the lower rotor system 122 includes only one lower blade 130. Each of the upper blade 126 and the lower blade 130 is located radially away from the lower hub 128.

The upper blade 126 is coupled to the upper hub 124 such that upper blade 126 co-rotates with the upper hub 124 and the lower blade 130 co-rotates with the lower hub 128. The upper hub 124 and the lower hub 128 are arranged in a vertically stacked formation on the top of the mid-fuselage 108 of the fuselage 102. Moreover, the upper hub 124 and the lower hub 128, and thus the upper blade 126 and the lower blade 130, are configured to rotate about a rotary axis (e.g., vertical axis) that is parallel to a yaw axis 144 of the aircraft 100. Accordingly, the upper blade 126 and the lower blade 130 experience co-axial rotation. However, the upper hub 124 and the upper blade 126 rotate in a clockwise rotational direction 180 and the lower hub 128 and the lower blade 130 rotate in a counter-clockwise rotational direction 182. The clockwise rotational direction 180 is opposite the counter-clockwise rotational direction 182. In other words, the upper blade 126 and the lower blade 130 rotate in opposite directions as shown in FIG. 2. The upper blade 126 could rotate in the counter-clockwise rotational direction 182 and the lower blade 130 could rotate in the clockwise rotational direction 180 as long as the upper blade 126 and the lower blade 130 rotate in the opposite directions.

The upper blade 126 and the lower blade 130 do not obstruct each other because the upper blade 126 and the lower blade 130 are offset from each other in a direction (e.g., vertical direction) parallel to the yaw axis 144. For example, referring to FIG. 11, the upper blade 126 is offset from the lower blade 130 by a distance ΔH. Although the upper blade 126 and the lower blade 130 rotates in opposite directions, rotation of the upper blade 126 and the lower blade 130 can be initiated synchronously, stopped synchronously, and rotated at the same rotational speed. However, it is possible to rotate the upper blade 126 and the lower blade 130 at slightly different speeds to develop a yawing moment for yaw control purposes. According to an example, the rotor system 118 further includes a brake configured to stop rotation of the upper rotor system 120 and the lower rotor system 122.

As defined, the pitch axis 142 is perpendicular to the roll axis 140. Moreover, the yaw axis 144 is perpendicular to both the roll axis 140 and the pitch axis 142. The roll axis 140 is the axis about which the aircraft 100 rotates to change a roll position of the aircraft 100 during flight. The pitch axis 142 is the axis about which the aircraft 100 rotates to change a pitch position of the aircraft 100 during flight. The yaw axis 144 is the axis about which the aircraft 100 rotates to change a yaw position of the aircraft 100 during flight. The roll axis 140, the pitch axis 142, and the yaw axis 144 pass through a center of gravity of the aircraft 100.

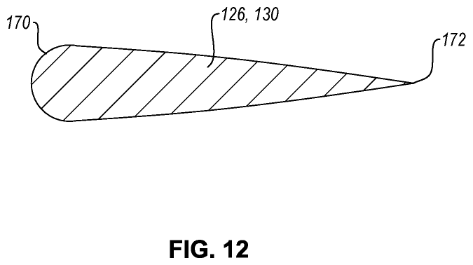

As shown in FIG. 12, the cross-sectional shape of each one of the upper blade 126 and the lower blade 130 at any location spanwise along the blade is an airfoil with a blunt leading edge 170 and a sharp converging trailing edge 172. The upper blade 126 is oriented such that the leading edge 170 of the upper blade 126 leads the upper blade 126 in the clockwise rotational direction 180 or faces the clockwise rotational direction 180. Similarly, the lower blade 130 is oriented such that the leading edge 170 of the lower blade 130 leads the lower blade 130 in the counter-clockwise rotational direction 182 or faces the counter-clockwise rotational direction 182. Because of the traditional airfoil shape of the upper blade 126 and the lower blade 130, the lift efficiency of the upper blade 126 and the lower blade 130 (e.g., the ability of the upper blade 126 and the lower blade 130 to generate lift) is enhanced as compared to a rotor that has two blunt edges because such a rotor must serve as a rotor and as a fixed wing.

Referring to FIG. 1, rotation of the upper hub 124, and thus the upper blade 126, and rotation of the lower hub 128, and thus the lower blade 130, is driven by a rotational power source 132 of the aircraft 100. The rotational power source 132 is coupled to, and can be housed within, the fuselage 102 of the aircraft 100. In one example, the rotational power source 132 is one or more engines, such as a turboshaft engine and/or turbofan engine, or an electrically-driven motor. A rotational output of the rotational power source 132 can be co-rotatably coupled to the upper hub 124 and the lower hub 128 to rotationally drive the upper hub 124 in the clockwise rotational direction 180 and to rotationally drive the lower hub 128 in the counter-clockwise rotational direction 182. In some examples, the fuselage 102 includes air inlet ports 150 to entrain air used in a combustion-driven process by the rotational power source 132 to generate power for rotation of the upper hub 124 and the lower hub 128.

The upper rotor system 120 and the lower rotor system 122 each includes a rotor blade pitch control system 190 that rotatably couples the upper blade 126 to the upper hub 124 and rotatably couples the lower blade 130 to the lower hub 128. The rotor blade pitch control system 190 of the upper rotor system 120 is selectively operable to change a pitch of the upper blade 126, relative to the upper hub 124, by rotating the upper blade 126 about a pitch axis of the upper blade 126 (as indicated by directional arrows 192). Similarly, the rotor blade pitch control system 190 of the lower rotor system 122 is selectively operable to change a pitch of the lower blade 130, relative to the lower hub 128, by rotating the lower blade 130 about a pitch axis 192 of the lower blade 130 (as indicated by directional arrows 192). Each pitch control system 190 can include any of various components, such as actuators, motors, and the like.

Referring to FIGS. 2 and 4, the pitch of the a rotor disc 152 of each of the upper blade 126 and the lower blade 130, mechanized by pitching the upper hub 124 and the lower hub 128, respectively, can also be adjusted (e.g., tilted at an angle β) to tilt the lift vector produced by rotor system 118 causing some of the lift of the rotor system 118 to become thrust for the aircraft 100. The rotor disc 152 of each of the upper blade 126 and the lower blade 130 is defined as the planar circular area swept through by the upper blade 126 and the lower blade 130, respectively, as the upper blade 126 and the lower blade 130 rotates.

Although not shown, the upper rotor system 120 includes a counter-weight on a side of the upper hub 124 opposite a rotor blade root 176 of the upper blade 126 in most examples. Likewise, the lower rotor system 122 includes a counter-weight on a side of the lower hub 128 opposite the rotor blade root 176 of the lower blade 130 in most examples. The counter-weights have the same mass as the corresponding upper blade 126 and the lower blade 130 to ensure balanced rotation of the upper blade 126 and the lower blade 130.

The aircraft 100 also includes a forward-thrust power source coupled to, and can be housed within, the fuselage 102 of the aircraft 100 or mounted external to the fuselage, such as in pods (not shown). The forward-thrust power source can be one or more engines, such as a turbofan engine or an electrically-driven face, configured to generate thrust for propelling the aircraft 100 forward. In one example, thrust generated by the forward-thrust power source is emitted from the forward-thrust port 138 coupled to the top of the fuselage 102. In some implementations, the rotational power source 132 doubles as the forward-thrust power source by generating both rotational power, to rotationally drive the upper rotor system 120 and the lower rotor system 122, and forward thrust to propel the aircraft 100 forward. According to one example, the rotational power source 132 may generate forward thrust by redirecting and accelerating exhaust from the rotational power source 132 through exhaust ports formed in the fuselage 102.

The aircraft 100 may also include thrust ports formed in the fuselage 102 and through which exhaust from the rotational power source 132 and/or the forward-thrust power source is selectively expelled. The thrust ports are formed in the aft fuselage 104 or aft portion of the fuselage 102.

In one example, the thrust ports include yaw thrust ports 134 each in a corresponding one of opposing sides of the aft fuselage 104. As shown in FIGS. 2, 3, 5, and 6, yaw thrust 162 is expelled from the yaw thrust ports 134 in directions parallel to the pitch axis 142 of the aircraft 100. The yaw thrust 162 acts to rotate the aircraft 100 about the yaw axis 144. In this manner, adjustments to the yaw of the aircraft 100 can be made, particularly during the vertical take-off mode of the aircraft 100 and during slow forward rotary flight at speed below the speed at which the empennage 116 will be aerodynamically effective.

It is recognized that the aircraft 100 does not include a tail rotor in some implementations. Tail rotors are utilized in rotorcraft (e.g., helicopters) to counter the yaw rotation induced by the blades of the rotorcraft all rotating in the same rotational direction. Because the aircraft 100 of the present disclosure includes counter-rotating blades, yaw rotation induced by the counter-rotating blades can be used for yawing control moments, sometimes a zero yawing moment. Accordingly, a tail rotor is not needed in the aircraft 100. However, to provide some adjustment of yaw, such as while operating in the vertical take-off mode, due to yaw rotation of the aircraft 100 caused by external considerations, such as wind, desired directional changes, and the like, the aircraft 100 includes the yaw thrust ports 134 in addition to yaw control moments through differential rotational speeds of the blades.

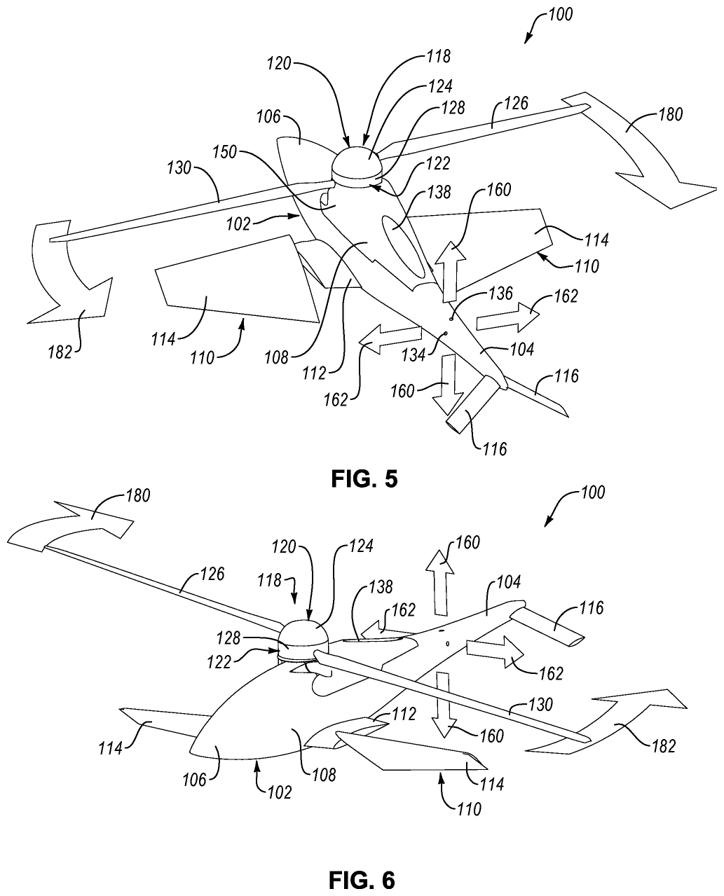

According to one example, the thrust ports include pitch thrust ports 136 each in a corresponding one of a top and a bottom of the aft fuselage 104. As shown in FIGS. 5 and 6, pitch thrust 160 is expelled from the pitch thrust ports 136 in directions parallel to the yaw axis 144 of the aircraft 100. The pitch thrust 160 acts to rotate the aircraft 100 about the pitch axis 142. In this manner, adjustments to the pitch of the aircraft 100 can be made, particularly during the vertical take-off mode of the aircraft 100 and at speeds below which the empennage becomes effective.

Referring to FIG. 4, the aircraft 100 includes landing gear 164. In the illustrated example, the landing gear 164 is configured to facilitate vertical take-offs and landings (e.g., those associated with rotorcraft) and horizontal take-offs and landings (e.g., those associated with airplanes). The landing gear 164 can be any of various conventional landing gear known in the art. As shown, the landing gear 164 includes a wheel and a strut portion coupling the wheel to the fuselage 102. In most implementations, due to the relatively high cruise speed of the aircraft 100, the landing gear 164 is retractable. In alternative examples, the landing gear of the aircraft 100 is configured only for vertical take-offs and landings, such as found on many conventional rotorcraft. For example, in one implementation, the landing gear of the aircraft 100 includes landing skids, which may also be retractable. In some implementations the landing gear will enable conventional take-off from a runway like an airplane that may also enable higher gross weight take-offs than could be achieved vertically.

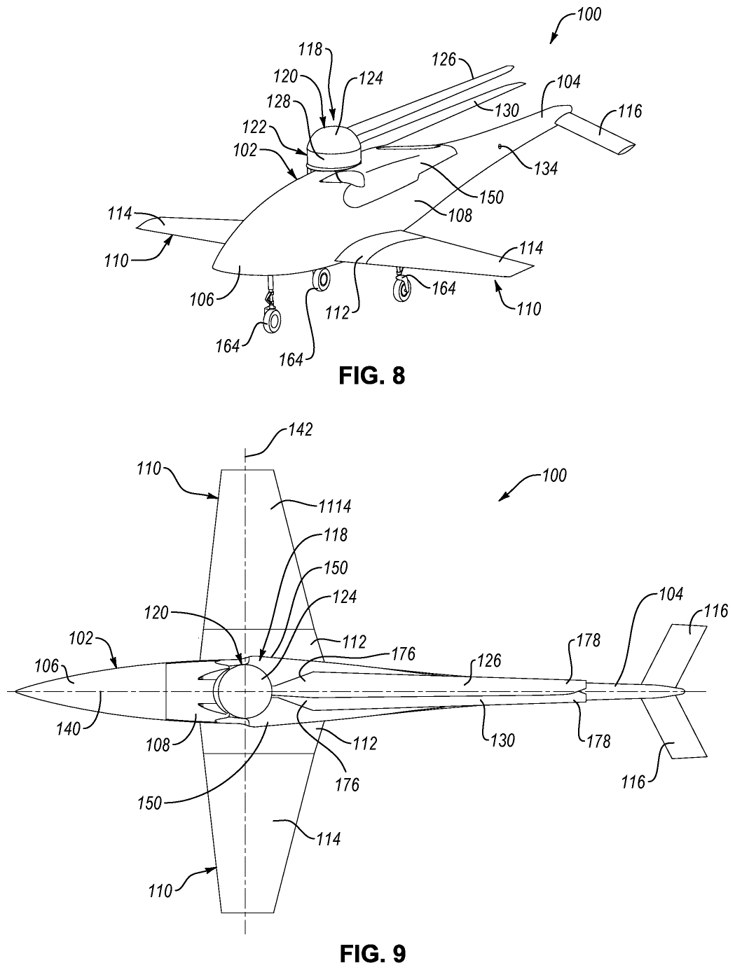

The aircraft 100 is operable in a vertical take-off mode with the upper and lower rotor systems turning (see, e.g., FIGS. 1-4), a low-speed forward rotary flight mode (see, e.g., FIGS. 5-7), and a high-speed cruise mode with the upper and lower rotor systems stopped and stowed along the fuselage 102 (see, e.g., FIGS. 8-11). According to one example, flight of the aircraft 100 from take-off to landing includes, in order: (1) operating the aircraft 100 in the vertical take-off mode to vertically lift the aircraft 100 from a ground surface to a height above the ground surface; (2) operating the aircraft 100 in the low-speed forward rotary flight mode to horizontally propel the aircraft 100 up to a transition speed; (3) operating the aircraft 100 at the transition speed until the upper and lower rotor systems are stopped; (4) operating the aircraft 100 in the high-speed cruise mode to horizontally move the aircraft 100 at some speed higher than the transition speed; (5) operating the aircraft 100 in the high-speed cruise mode but decelerating to the transition speed; (6) operating the aircraft 100 at the transition speed until the upper and lower rotor systems are rotating at the full speed required for low-speed forward rotary flight mode; (70) operating the aircraft 100 in the low-speed forward rotary flight mode after slowing down the aircraft to below the transition speed; and (8) operating the aircraft 100 in the vertical take-off mode to vertically lower the aircraft 100 back onto the same or a different ground surface.

Referring to FIGS. 1-4, in the vertical take-off mode, the pitchable wing 114 of the fixed wings 110 are rotated to be substantially parallel to the yaw axis 144. In other words, in the vertical take-off mode, the pitchable wings 114 of the fixed wings 110 are pitched at an angle θ, relative to the roll axis 140, of approximately 90° to minimize rotor download on the fixed wings 110. In one example, in the vertical take-off mode, the angle θ between the pitchable wings 114 of the fixed wings 110 and the roll axis 140 is about 90°. Moreover, in the vertical take-off mode, the upper blade 126 and the lower blade 130 are pitched to maximize vertical lift and are counter-rotating as presented above. With the upper blade 126 and the lower blade 130 pitched for maximum vertical lift and counter-rotating, the upper blade 126 and the lower blade 130 generate a downwash in a downward direction parallel to the yaw axis 144. The generation of downwash results in a lift force acting on the upper blade 126 and the lower blade 130, which, when exceeding the weight of the aircraft 100 (among other factors), vertically lifts the aircraft 100 off of a ground surface on which the aircraft 100 was supported. With the pitchable wings 114 of the fixed wings 110 pitched at an angle θ of approximately 90°, the pitchable wings 114 minimize the download generated by the upper blade 126 and the lower blade 130.

The transition from the vertical take-off mode to the low-speed forward rotary flight mode can be initiated after the aircraft 100 reaches a desired altitude or height above the ground surface. Referring to FIGS. 5-7, in the low-speed forward rotary flight mode, the upper blade 126 and the lower blade 130 are pitched and counter-rotating. With the upper blade 126 and the lower blade 130 pitched and counter-rotating, the upper blade 126 and the lower blade 130 generate an angled downwash with a vertical vector and a horizontal vector. The vertical vector of the angled downwash provides some of the lift of the aircraft 100 and the horizontal vector of the angled downwash provides the forward thrust of the aircraft 100. In the low-speed forward rotary flight mode, the pitchable wings 114 of the fixed wings 110 are rotated such that the pitch of the pitchable wings 114 is reduced to an angle θ less than that during the vertical take-off mode to minimize download from the rotor wash. According to one example, the angle θ is between 0° and 90° or oblique to the roll axis 140 and the yaw axis 144. Therefore, in the low-speed forward rotary flight mode, the vertical vector of the angled wash provides some of the lift of the aircraft 100 and the pitchable wings 114 of the fixed wings 110 provides the rest of the lift of the aircraft 100. In some examples, in the low-speed forward rotary flight mode, the horizontal vector of the angled wash provides all of the forward thrust of the aircraft 100. However, in alternative examples, in the low-speed forward rotary flight mode, the horizontal vector of the angled wash provides a portion of the forward thrust of the aircraft 100 and a separate forward-thrust power source provides the rest of the forward thrust.

In the low-speed forward rotary flight mode, in most examples, the pitch of the upper blade 126 and the lower blade 130 and the pitch of the pitchable wings 114 of the fixed wings 110 are adjusted based on a desired forward velocity and desired rotary lift of the aircraft 100.

Forward flight of the aircraft 100 in the low-speed forward rotary flight mode is accomplished by generating forward thrust. Forward thrust of the aircraft 100 in the low-speed rotary flight mode is generated by rotation of the upper blade 126 and the lower blade 130 (pitched to generate a horizontal thrust vector), an auxiliary forward-thrust power source (e.g., exhaust from the rotational power source 132 and/or a dedicated forward-thrust power source), or some combination of rotation of the upper blade 126 and the lower blade 130 and the auxiliary forward-thrust power source. In other words, the forward thrust generated during the low-speed forward rotary flight mode can come solely from rotation of the upper blade 126 and lower blade 130 when pitched, solely from an auxiliary forward-thrust power source (with the upper blade 126 and lower blade 130 still rotating but not generating forward thrust), or a combination of both. When a combination of both is desired, the ratio of forward thrust generated from each source can vary based on any of various factors, such as the speed of the vehicle 100, the pitch of the aircraft 100, environmental conditions (e.g., wind speed and direction), and the like.

The amount of forward thrust generated by rotation of the upper blade 126 and the lower blade 130 is adjustable in a few different ways. For example, the pitch of the upper blade 126 and the lower blade 130 can be adjusted to increase or decrease the forward thrust of the aircraft 100 generated by the upper blade 126 and the lower blade 130. The pitch of the pitchable wings 114 of the fixed wings 110 can be correspondingly adjusted. As another example, the rotational rate of speed of the upper blade 126 and the lower blade 130 can be adjusted to increase or decrease the forward thrust of the aircraft 100 generated by the upper blade 126 and the lower blade 130. Similarly, the amount of forward thrust generated by the forward-thrust power source can also be adjusted to increase or decrease the forward thrust of the aircraft 100 generated by the forward-thrust power source.

The transition from the low-speed forward rotary flight mode to the high-speed cruise mode can be initiated after the aircraft 100 reaches a desired speed. In some examples, the desired transition speed is between about 110 knots (57 m/s) and about 130 knots (67 m/s). According to one example, the desired speed is about 120 knots (62 m/s). A higher transition speed may require an aircraft to be designed for more rotor vibration due to the vehicle forward speed combining with the speed of the advancing rotor tip and the shock waves that form periodically with the rotor rotation. This may happen at a transition speed closer to 160 knots. A lower transition speed will require the aircraft to carry higher high speed cruise drag due to the wing having more planform area than needed for an aircraft designed with a higher transition speed.

Referring to FIGS. 8-11, in the high-speed cruise mode, the upper blade 126 and the lower blade 130 are unpitched and not rotating. More specifically, in the high-speed cruise mode, rotation of the upper blade 126 and the lower blade 130 is halted with the upper blade 126 and the lower blade 130 in a corresponding one of a first rearward orientation and a second rearward orientation both parallel to the roll axis 140 of the aircraft 100. This blade rotation stoppage is usually done by applying a carbon brake, like a car brake, and a timing algorithm to ensure a correct stopped blade position. Because the upper blade 126 and the lower blade 130 rotate about a common axis, when in the first rearward orientation and the second rearward orientation and when viewed from a top view (see, e.g., FIG. 4), the upper blade 126 partially overlaps the lower blade 130 in a direction (e.g., vertical direction) parallel to the yaw axis 144. Put another way, in the high-speed cruise mode, the upper blade 126 and the lower blade 130 extend in a rearward direction relative to the fuselage 102 from corresponding rotor blade roots 176 to corresponding free ends 178 of the upper blade 126 and the lower blade 130.

With the upper blade 126 and the lower blade 130 unpitched and stationary in the rearward orientation, there is no drag or pitching and rolling moments induced by the upper blade 126 and the lower blade 130 during high-speed forward flight of the aircraft 100. Accordingly, control of the flight of the aircraft 100 is improved and cruise speeds reachable by the aircraft 100 are higher compared to other stopped rotor vehicles. Additionally, because the upper blade 126 and the lower blade 130 experience no fixed wing bending due to the generation of fixed wing lift, the upper blade 126 and the lower blade 130 need not be as structurally stiff or heavy as blades of other stopped rotor vehicles, which allows the aircraft 100 to be lighter and less complex than other stopped rotor vehicles.

Additionally, in the high-speed cruise mode, the pitchable wings 114 of the fixed wings 110 are unpitched relative to the first portions 112. Put another way, in the high-speed cruise mode, the pitchable wings 114 are at a target pitch or a target angle θ relative to the roll axis 140 equal to a target pitch angle. The target pitch or the target pitch angle is typically near 2° so that the fixed wing produces the correct lift to offset the weight of the vehicle. Because the pitchable wings can be adjusted in flight, the target pitch may be a degree or two higher when the aircraft is heavy or a degree or two lower when the aircraft is light. The goal is to set the pitchable wings at an angle to the fuselage so that the fuselage is aligned with the flight path angle and in a minimum drag configuration.

Presented above is one example of a process of transitioning from take-off to high-speed cruising of the aircraft 100. It is recognized that a transition from high-speed cruising to landing of the aircraft 100 can be accomplished in a substantially reversed manner.

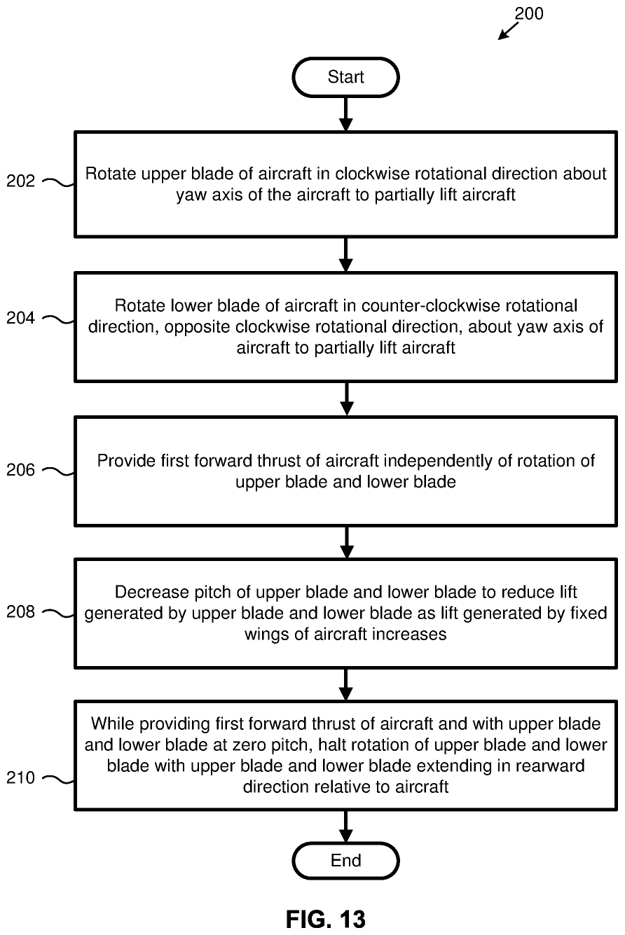

Referring to FIG. 13, according to one example, a method 200 of flying the aircraft 100, which has fixed wings 110, includes rotating the upper blade 126 of the aircraft 100 in the clockwise rotational direction 180 about the yaw axis 144 of the aircraft 100 to partially lift the aircraft 100 at 202. The method 200 also includes rotating the lower blade 130 of the aircraft 100 in the counter-clockwise rotational direction 182, opposite the clockwise rotational direction 180, about the yaw axis 144 of the aircraft 100 to partially lift the aircraft 100 at 204. The method 200 additionally includes providing a first forward thrust of the aircraft 100 independently of rotation of the upper blade 126 and the lower blade 130 at 206. The method 200 further includes decreasing the pitch of the upper blade 126 and the lower blade 130, to reduce lift generated by the upper blade 126 and the lower blade 130, as lift generated by the fixed wings 110 increases. The method 200 also includes, while providing the first forward thrust of the aircraft 100 and with the upper blade 126 and the lower blade 130 at zero pitch, halting the rotation of the upper blade 126 and the lower blade 130 with the upper blade 126 and the lower blade 130 extending in a rearward direction relative to the aircraft 100 at 208. The rearward direction can be parallel to the roll axis 140 of the aircraft 100 and, when rotation of the upper blade 126 and the lower blade 130 is halted, the upper blade 126 overlaps the lower blade 130 in a direction parallel to the yaw axis 144 of the aircraft 100.

In some examples, the method 200 additionally includes pitching the upper blade 126 and the lower blade 130 to provide a second forward thrust of the aircraft 100 from rotation of the upper blade 126 and the lower blade 130. The method 200 also includes providing at least one of a pitch adjustment thrust and a yaw adjustment thrust of the aircraft 100 while rotating the upper blade 126 and the lower blade 130 in some examples.

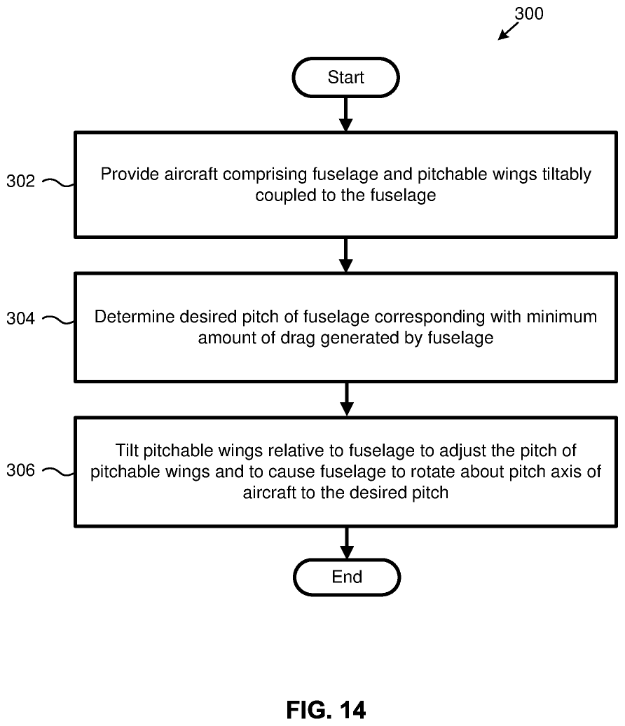

Referring to FIG. 14, according to one additional example, a method 300 of flying an aircraft includes providing, at step 302, an aircraft that includes a fuselage, such a fuselage 102, and pitchable wings, such as pitchable wings 114, tiltably coupled to the fuselage. The pitchable wings are selectively tiltable about an axis parallel to a pitch axis of the aircraft to adjust a pitch of the pitchable wings relative to the fuselage. In some implementations, the aircraft includes rotors and, in other implementations, the aircraft does not include any rotors. At step 304 of the method 300, a desired pitch of the fuselage is determined. The desired pitch corresponds with a minimum amount of drag generated by the fuselage 102. The drag generated by a fuselage is dependent on several factors, including the pitch of the fuselage. For a given set of flight parameters, such as speed of the aircraft, wind speed, wind direction, and weight of the aircraft, among others, there is a pitch of the fuselage at which the fuselage generates minimum drag. This pitch is defined as the desired pitch of the fuselage and can be calculated based on one or more of the above-mentioned factors. In some examples, the desired pitch is zero. The method 300 further includes, at step 306, tilting the pitchable wings relative to the fuselage to adjust the pitch of the pitchable wings and to cause the fuselage to rotate about the pitch axis to the desired pitch. In some examples, tilting the pitchable wings at step 306 includes increasing the pitch of the pitchable wings (e.g., increasing the angle β described above), which acts to increase the lift generated by the pitchable wings and to rotate the fuselage downwardly into the desired pitch.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An aircraft, comprising:
a fuselage comprising a forward fuselage and a rear fuselage, wherein the fuselage extends parallel to a roll axis of the aircraft from the forward fuselage to the rear fuselage;
fixed wings coupled to the fuselage and extending from opposite sides of the fuselage in directions parallel or oblique to a pitch axis of the aircraft, wherein the pitch axis is perpendicular to the roll axis;
an upper rotor system coupled to the fuselage, wherein the upper rotor system comprises only one upper blade and is configured to:
rotate the upper blade in a clockwise rotational direction about a yaw axis of the aircraft in a vertical take-off mode, wherein the yaw axis is perpendicular to the roll axis and the pitch axis; and
halt rotation of the upper blade in a first rearward orientation parallel to the roll axis of the aircraft in a high-speed cruise mode; and
a lower rotor system coupled to the fuselage, wherein the lower rotor system comprises only one lower blade and is configured to:
rotate the lower blade in a counter-clockwise rotational direction, opposite the clockwise rotational direction, about the yaw axis in the vertical take-off mode; and
halt rotation of the lower blade in a second rearward orientation parallel to the roll axis in the high-speed cruise mode.

2. The aircraft according to claim 1, wherein the upper blade is offset from the lower blade in a direction parallel to the yaw axis.

3. The aircraft according to claim 1, wherein each fixed wing comprises a fixed wing root, non-movably fixed relative to the fuselage, and a pitchable wing, rotatably coupled to the fixed wing root and rotatable relative to the fixed wing root.

4. The aircraft according to claim 3, wherein:
the pitchable wing is substantially parallel to the yaw axis in the vertical take-off mode; and
the pitchable wing is substantially parallel to the roll axis in the high-speed cruise mode.

5. The aircraft according to claim 1, further comprising pitch thrust ports each in a corresponding one of a top and a bottom of the rear portion of the fuselage.

6. The aircraft according to claim 1, further comprising yaw thrust ports each in a corresponding one of opposing sides of the rear portion of the fuselage.

7. The aircraft according to claim 1, wherein each of upper blade and the lower blade has an airfoil cross-sectional shape with a blunt leading edge and a pointed trailing edge.

8. The aircraft according to claim 1, further comprising a forward thrust system separate from the upper rotor system and the lower rotor system.

9. The aircraft according to claim 1, wherein, in the high-speed cruise mode, the upper blade at least partially overlaps the lower blade in a direction parallel to the yaw axis.

10. The aircraft according to claim 1, wherein:
a pitch of the upper blade and the lower blade is adjustable;
the pitch of the upper blade and the lower blade is zero during the vertical take-off mode and the high-speed cruise mode; and
the pitch of the upper blade and the lower blade is greater than zero during a low-speed forward rotary flight.

11. The aircraft according to claim 10, wherein:
the upper blade and the lower blade are configured to provide at least a portion of forward thrust and lift of the aircraft during the low-speed forward rotary flight; and
the upper blade and the lower blade are configured to provide no thrust and no lift of the aircraft during the high-speed cruise mode.

12. A vertical take-off and landing (VTOL) aircraft, comprising:
a fuselage;
fixed wings coupled to the fuselage;
an upper blade rotatably coupled to the fuselage and rotatable about a rotational axis parallel to a yaw axis of the VTOL aircraft in a clockwise rotational direction; and
a lower blade rotatably coupled to the fuselage and rotatable about the rotational axis in a counter-clockwise rotational direction opposite the clockwise rotational direction;
wherein rotation of the upper blade and the lower blade is haltable, during flight of the VTOL aircraft, with the upper blade and the lower blade extending in a rearward direction relative to the fuselage from corresponding rotor blade roots to corresponding free ends of the upper blade and the lower blade.

13. The VTOL aircraft according to claim 12, wherein the upper blade is vertically offset from the lower blade when rotation of the upper blade and the lower blade is halted with the upper blade and the lower blade extending in a rearward direction from corresponding fixed ends to corresponding free ends of the upper blade and the lower blade.

14. The VTOL aircraft according to claim 12, wherein each of upper blade and the lower blade has an airfoil cross-sectional shape with a blunt leading edge and a pointed trailing edge.

15. The VTOL aircraft according to claim 12, wherein:
in a vertical take-off mode, the upper blade and the lower blade provide all lift of the VTOL aircraft;
in a low-speed forward rotary flight, the upper blade and the lower blade provide at least some lift and at least some forward thrust of the VTOL aircraft; and
in a high-speed cruise mode, the upper blade and the lower blade provide no lift and no forward thrust of the VTOL aircraft.

16. The VTOL aircraft according to claim 15, wherein:
in the vertical take-off mode, the upper blade and the lower blade are not pitched;
in the low-speed forward rotary flight, the upper blade and the lower blade are pitched; and
in the high-speed cruise mode, the upper blade and the lower blade are not pitched.

17. A method of flying an aircraft comprising fixed wings, the method comprising:
rotating an upper blade of the aircraft in a clockwise rotational direction about a yaw axis of the aircraft to partially lift the aircraft;
rotating a lower blade of the aircraft in a counter-clockwise rotational direction, opposite the clockwise rotational direction, about the yaw axis of the aircraft to partially lift the aircraft;
providing a first forward thrust of the aircraft independently of rotation of the upper blade and the lower blade;
decreasing pitch of the upper blade and the lower blade, to reduce lift generated by the upper blade and the lower blade, as lift generated by the fixed wings increases; and
while providing the first forward thrust of the aircraft and with the upper blade and the lower blade at zero pitch, halting the rotation of the upper blade and the lower blade with the upper blade and the lower blade extending in a rearward direction relative to the aircraft.

18. The method according to claim 17, further comprising pitching the upper blade and the lower blade to provide a second forward thrust of the aircraft from rotation of the upper blade and the lower blade.

19. The method according to claim 17, further comprising providing at least one of a pitch adjustment thrust and a yaw adjustment thrust of the aircraft while rotating the upper blade and the lower blade.

20. The method according to claim 17, wherein the rearward direction is parallel to a roll axis of the aircraft and, when rotation of the upper blade and the lower blade is halted, the upper blade overlaps the lower blade in a direction parallel to a yaw axis of the aircraft.

21. A method of flying an aircraft, the method comprising:
providing an aircraft comprising a fuselage and pitchable wings tiltably coupled to the fuselage, wherein the pitchable wings are selectively tiltable about an axis parallel to a pitch axis of the aircraft to adjust a pitch of the pitchable wings relative to the fuselage;
determining a desired pitch of the fuselage corresponding with a minimum amount of drag generated by the fuselage; and
tilting the pitchable wings relative to the fuselage to adjust the pitch of the pitchable wings and to cause the fuselage to rotate about the pitch axis to the desired pitch.
